(19) United States
(12) Patent Application Publication
(10) Pub. No.: US 2021/0001240 A1
(43) Pub. Date: Jan. 7, 2021

(54) TOY BUILDING BRICKS MADE OF BIOPOLYMERIC MATERIAL

(71) Applicant: LEGO A/S, Billund (DK)

(72) Inventors: René MIKKELSEN, Billund (DK); Søren KRISTIANSEN, Billund (DK); Bistra ANDERSEN, Billund (DK); Louise Tosti JOHANSEN, Billund (DK); Mikael KRISTENSEN, Billund (DK); Caroline Johanna WOLF, Billund (DK); Hanna Kristina MERRILD, Billund (DK)

(21) Appl. No.: 16/767,215

(22) PCT Filed: Nov. 30, 2018
(86) PCT No.: PCT/EP2018/083090

§ 371 Date: May 27, 2020

(30) Foreign Application Priority Data
Dec. 1, 2017 (DK) PA 2017 70901

(51) Int. Cl. A63H 33/08; B29C 45/00; B29C 64/10; B33Y 10/00; B33Y 80/00

(52) U.S. Cl. CPC A63H 33/086; B29C 45/0001; B29C 64/10; B29K 2105/26; B33Y 80/00; B29K 2995/0056; B33Y 10/00

(57) ABSTRACT

The present invention relates to toy building elements made of a biopolymeric material. The present invention also relates to a method of manufacturing said toy building elements.

### FIELD OF THE INVENTION

The present invention relates to toy building elements made of a biopolymeric material. The present invention also relates to a method for the manufacturing of said toy building elements.

### BACKGROUND

Toy building elements have been manufactured and marketed for many years. Traditionally such toy building elements are made of petroleum-based polymers, such as ABS. The increasing concern about diminishing petroleum resources and the impacts of the global warming, however, has encouraged development of alternative sustainable materials for use in the manufacturing of toy building elements as well as other kinds of toys. Today there is only one renewable alternative for the production of petroleum-based polymers and that is the use of bio-based polymers, which are produced using biomass as the renewable resource.

One type of toy building elements can be characterised as the traditional box-shaped building bricks provided with knobs on the upper side and complementary tubes on the lower side. Such box-shaped building bricks were disclosed for the first time in U.S. Pat. No. 3,005,282 and are today manufactured and sold in two sizes: the traditional LEGO®-size and the larger LEGO® DUPLO®-size.

Some toy building bricks of a size similar to the LEGO® DUPLO®-size have been introduced on the market for example by the Chinese toy company BanBao. These building bricks have been marketed as being made of sustainable bio-based polyethylene materials where the polyethylene has been produced using sugarcane as the renewable resource.

Toy building elements of the traditional LEGO®-size have not yet been produced in sustainable bio-based material. The challenges of manufacturing the LEGO®-sized bricks are greater than compared with manufacturing of the larger LEGO® DUPLO®-sized toy building bricks for a number of reasons. One of these reasons is directed to the requirements relating to surface characteristics of the bricks, which are more demanding for the LEGO® bricks than for the LEGO® DUPLO® bricks.

In general, the LEGO® DUPLO®-sized bricks are manufactured for use as toys for children in the age of 2 to 5 years, and the main demand to the LEGO® DUPLO® bricks is to stack the bricks on top of each other without creating long-lasting constructions which can be moved from one place to another without the bricks falling apart. In contrary, the LEGO® bricks are manufactured as construction bricks, i.e. the purpose of the LEGO® bricks is to create larger, long-lasting constructions which can be moved from one place to another without the bricks falling apart. Hence, the coupling force of the LEGO® bricks is an important characteristic, which indicates the effort which is required for a person to assemble and separate the bricks and also indicates the bricks ability to stay assembled for many years in large, long-lasting constructions.

The inventors of the present invention have overcome these challenges and are today capable of manufacturing toy building bricks in biopolymeric material having surface characteristics which makes it possible to create long-lasting constructions that can be moved from one place to another without the bricks falling apart. The toy building elements can be manufactured by use of injection moulding and by additive manufacturing.

### SUMMARY OF THE INVENTION

The present invention relates to novel toy building elements that are made of biopolymeric material. The inventors of the present invention has surprisingly found that toy building elements of the LEGO®-size can be manufactured by processing of a resin comprising at least one bio-based polymer and/or at least one hybrid bio-based polymer and/or a recycled polymer.

In a first aspect the present invention relates to a toy building element which is made of biopolymeric materials.

In a second aspect the present invention relates a method for the manufacture of a toy building element which is made of biopolymeric materials.

### BRIEF DESCRIPTION OF THE FIGURES

FIG. 1 shows a traditional box-shaped LEGO® 2*4 brick of the LEGO®-size.

FIG. 2 shows a traditional box-shaped LEGO® 2*4 brick of the LEGO® DUPLO®-size.

### DETAILED DESCRIPTION OF THE INVENTION

The present invention is directed to toy building elements which are made of biopolymeric material.

The term “toy building element” as used herein includes the traditional toy building elements in the form of box-shaped building bricks provided with knobs on the upper side and complementary tubes on the lower side. The traditional box-shaped toy building bricks were disclosed for the first time in U.S. Pat. No. 3,005,282 and are widely sold under the tradenames LEGO® and LEGO® DUPLO®. The term also includes other similar box-shaped building bricks which are produced by other companies than The LEGO Group and therefore sold under other trademarks than the trademark LEGO.

The term “toy building element” also includes other kinds of toy building elements that form part of a toy building set which typically comprises a plurality of building elements that are compatible with and hence can be interconnected with each other. Such toy building sets are also sold under the trademark LEGO, such as for example LEGO® Bricks, LEGO® Technic and LEGO® DUPLO®. Some of these toy building sets includes toy building figures having complementary tubes on the lower side so that the figure can be connected to other toy building elements in the toy building set. Such toy building figures are also encompassed by the term “toy building element”. The term also includes similar toy building elements that are produced by other companies than The LEGO Group and therefore sold under other trademarks than the trademark LEGO.

The toy building elements are available in a large variety of shapes, sizes and colours. One difference between LEGO® bricks and LEGO® DUPLO® bricks is the size in that a LEGO® DUPLO® brick is twice the size of a LEGO® brick in all dimensions. The size of the traditional box-shaped LEGO® toy building brick having 4*2 knobs on the upper side is about 3.2 cm in length, about 1.6 cm in width and about 0.96 cm in height (excluding knobs), and the diameter of each knob is about 0.48 cm. In contrast, the size of a LEGO® DUPLO® brick having 4*2 knobs on the upper side is about 6.4 cm in length, about 3.2 cm in width and about 1.92 cm in height (excluding knobs), and the diameter of each knob is about 0.96 cm.

The above mentioned dimensions and sizes may vary at most 1% in order for toy building elements to be “compatible and thereby connectable” to each other.

In general there is a higher demand for dimensional precision when producing the smaller LEGO® bricks as compared with the larger LEGO® DUPLO® bricks, because it is more critical for the smaller bricks to exactly fit together so that the bricks are capable of being easily assembled and separated many times and also so that the bricks possess the ability to stay assembled for many years in large, long-lasting constructions.

Also the surface pressure between knobs and complementary tubes is higher for the LEGO® bricks than for the LEGO® DUPLO® bricks. Consequently, the demands to the material with regard to wear resistance, scratch resistance and creep/stress relaxation is much higher when producing the LEGO® bricks.

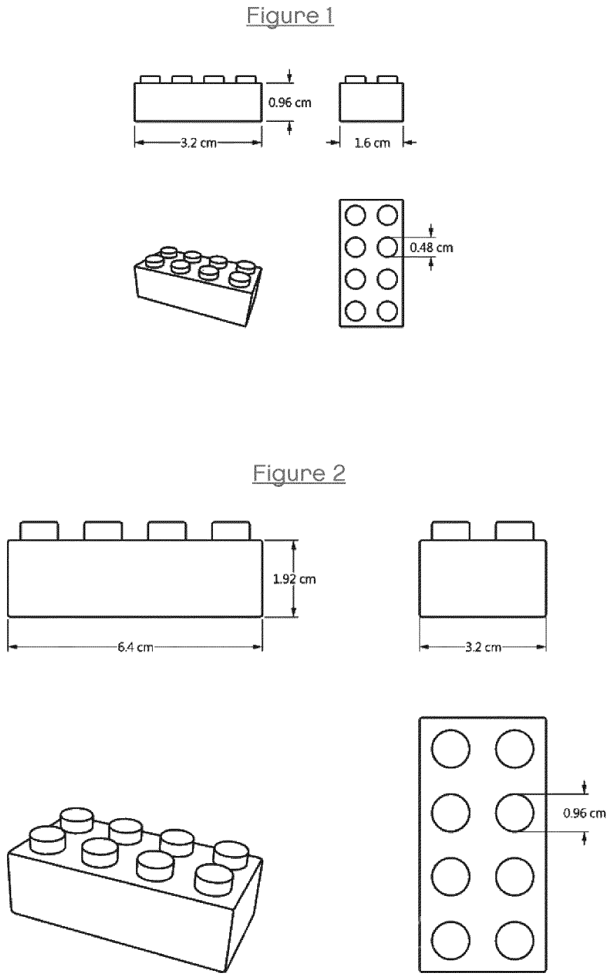

By the term “LEGO®-size” or “LEGO®-sized toy building element” as used herein is meant a toy building element which is either a traditional box-shaped LEGO® toy building brick as shown in FIG. 1 or any other kind of toy building element having knobs and/or complementary tubes of identical size as the LEGO® brick and which forms part in a toy building set sold under the trademarks LEGO® or LEGO® Technic. The term also includes similar bricks of the same or similar shape and size but produced by other companies than The LEGO Group and therefore sold under other trademarks than the trademark LEGO.

By the term “LEGO® DUPLO®-size” or “LEGO® DUPLO®-sized toy building element” as used herein is meant a toy building element which is either a traditional box-shaped LEGO® DUPLO® toy building brick as shown in FIG. 2 or any other kind of toy building element having knobs and/or complementary tubes of identical size as the LEGO® DUPLO® brick and which forms part in a toy building set which are sold under the trademark LEGO® DUPLO®. The term also includes similar bricks of the same or similar shape and size but produced by other companies than The LEGO Group and therefore sold under other trademarks than the trademark LEGO.

In one embodiment of the present invention the toy building element is a traditional box-shaped LEGO® toy building brick. In another embodiment of the present invention the toy building element is a traditional box-shaped LEGO® toy building brick or any other kind of toy building element that form part of a toy building set which typically comprises a plurality of building elements that are compatible with and therefore can be interconnected with each other and with the traditional box-shaped LEGO® toy building brick. In yet another embodiment the toy building element is a LEGO®-sized toy building element.

In one embodiment of the present invention the toy building element is a traditional box-shaped LEGO® DUPLO® toy building brick. In another embodiment of the present invention the toy building element is a traditional box-shaped LEGO® DUPLO® toy building brick or any other kind of toy building element that form part of a toy building set which typically comprises a plurality of building elements that are compatible with and therefore can be interconnected with each other and with the traditional box-shaped LEGO® DUPLO® toy building brick. In yet another embodiment the toy building element is a LEGO® DUPLO®-sized toy building element.

In a preferred embodiment the toy building element is a toy construction element. By the term “toy construction element” as used herein is meant a toy building element having the required surface characteristics so that it can be used as a brick forming part of a large, long-lasting construction which can be moved from one place to another without the bricks falling apart. The toy construction element may be of any shape, size and colour, i.e. the toy construction element may be identical to any toy building element as defined above in both LEGO®-size and LEGO® DUPLO®-size as long as its surface characteristics make it possible for it to form part of a long-lasting toy construction that can be moved from one place to another without the bricks falling apart.

The toy building elements are made of a biopolymeric material and manufactured by processing of a resin comprising a bio-based polymer and/or a hybrid bio-based polymer and/or a recycled polymer. By the term “biopolymeric material” as used herein is meant a material which is obtained after processing of a resin comprising at least one bio-based polymer or at least one hybrid bio-based polymer or a recycled polymer. The term includes materials that have been obtained after injection moulding or additive manufacturing of a resin comprising at least one bio-based polymer or at least one hybrid bio-based polymer or a recycled polymer.

In particular, the toy building elements are manufactured either by injection moulding or by additive manufacturing or by a combination of injection moulding and additive manufacturing.

Injection moulding of toy building elements is the traditional way of manufacturing toy building bricks. This manufacturing technique has been used for many years and is very well known to a skilled person.

In recent years the new additively manufacturing technique for building objects in for example polymeric material has been developed. By the term “additive manufacturing” or “additively manufactured” as used herein is meant that the brick is built in an additive fashion, i.e. by adding new material on top of either a substrate or on top of newly added material, by repeated solidification of a thin liquid layer or droplet on a substrate or on a previously solidified liquid layer or droplet, or by repeated printing with a thermoplastic polymeric material on a substrate or on a previously printed plastics material, or by repeated soldering in an additive fashion of plastics material e.g. by use of laser.

In some embodiments the toy building element is manufactured by injection moulding. In other embodiments the toy building element is manufactured by additive manufacturing. In yet other embodiments the toy building element is manufactured by a combination of injection moulding and additive manufacturing. Such combined manufacturing technique is described for example in WO 2014/005591 where a toy building element with high degree of design individuality is manufactured by adding material in the layer-by-layer fashion on the surface of a traditional injection moulded box-shaped building brick.

The resin which is processed into the toy building element comprises at least one bio-based polymer or at least one hybrid bio-based polymer or the resin comprises a recycled polymer.

By the term “bio-based polymer” as used herein is meant a polymer which is produced by chemical or biochemical polymerization of monomers derived from biomass. Bio-based polymers include polymers produced by polymerization of one type of monomer derived from biomass as well as polymers produced by polymerization of at least two different monomers derived from biomass.

In a preferred embodiment the bio-based polymer is produced by chemical or biochemical polymerization of monomers which are all derived from biomass.

Bio-based polymers can be divided into three groups:
1. Polymers produced by biochemical polymerization, i.e. for example by use of microorganisms. The monomers are produced using biomass as substrate. Examples of such polymers include polyhydroxyalkanoates, such as polyhydroxyvalerate and poly(hydroxybutyrate-hydroxyvalerate).
2. Polymers produced by chemical polymerization, i.e. by chemical synthesis. The monomers are produced using biomass as substrate. Examples of such polymers include polylactic acid.
3. Polymers derived from plants. The polymers are produced by biochemical processes inside of the plant typically during growth. The polymers are isolated and optionally subsequently modified. Examples of such polymers include modified cellulose such as for example cellulose acetate.

In some embodiments, the bio-based polymer is produced by biochemical polymerization. In other embodiments the bio-based polymer is produced by chemical polymerization. In yet other embodiments the bio-based polymer is produced by biochemical or chemical polymerization. In still other embodiments the bio-based polymer is derived from plants.

Bio-based polymers also include polymers having the same molecular structure as petroleum-based polymers, but which have been produced by chemical or biochemical polymerization of monomers derived from biomass.

By the term “petroleum-based polymers” as used herein is meant a polymer produced by chemical polymerization of monomers derived from petroleum, petroleum by-products or petroleum-derived feedstocks. Examples include polyethylene, polyethylene terephthalate and polymethylmethacrylate.

By the term “hybrid bio-based polymer” as used herein is meant a polymer which is produced by polymerization of at least two different monomers, where at least one monomer is derived from biomass and at least one monomer is derived from petroleum, petroleum by-products or petroleum-derived feedstocks. The polymerization process is typically a chemical polymerization process.

By the term “recycled polymers” as used herein is meant polymers which have been obtained by recovering scrap or waste plastic and reprocessing it into a useful polymeric material. The recycled polymeric material may comprise bio-based polymers and/or hybrid bio-based polymers and/or petroleum-based polymers. The term covers both mechanical recycled polymers and chemical recycled polymers. By the term “mechanical recycled polymers” is meant polymeric material which has been melted, optionally upgraded whereby the length of the polymer chains are increased, and then formed into pellets or the like for use in a subsequent injection moulding process or in the compounding process prior to injection moulding. By the term “chemical recycled polymers” is meant polymeric material which is obtained by chemically degrading polymeric material to its monomers and/or oligomers, for example by use of microorganisms, purifying the monomers/oligomers and then polymerizing the monomers/oligomers to obtain recycled polymers.

In some embodiments the bio-based polymer is selected from the group consisting of polylactic acid (PLA), polyethylene (PE), polypropylene (PP), polyglycolic acid (PGA), poly(lactide-co-glycolide) (PLGA), polybutylene succinate (PBS), polytrimethylene furandicarboxylate (PTF), polyhydroxybutyrate (PHB), polyhydroxyvalerate (PHV), poly(hydroxybutyrate-hydroxyvalerate) (PHBV), polyamide (PA), polyester amide (PEA), polyethylene furanoate (PEF), polyebutylene furanoate (PBF), polyethylene terephthalate (PET), polyethylene terephthalate glycol-modified (PETG), polyethylene terephthalate—isophthalic acid copolymer (PET-IPA), polyethylene terephthalate naphthalene (PETN), polybutylene terephthalate (PBT), polytrimethylene terephthalate (PTT), thermoplastic polyurethane (TPU), cellulose acetate (CA), thermoplastic starch (TPS), diphenylisosorbide, polyvinyl acetate (PVA) and polymethyl methacrylate (PMMA).

In one embodiment the bio-based polymer is not cellulosic material. In another embodiment the bio-based polymer is not polyethylene (PE). In yet another embodiment the bio-based polymer is not polypropylene (PP).

In some embodiments the hybrid bio-based polymer is selected from the group consisting of poly(lactide-co-glycolide) (PLGA), polybutylene succinate (PBS), polytrimethylene furandicarboxylate (PTF), polyamide (PA), polyester amide (PEA), polyethylene furanoate (PEF), polyebutylene furanoate (PBF), polyethylene terephthalate (PET), polybutylene terephthalate (PBT), polytrimethylene terephthalate (PTT), thermoplastic polyurethane (TPU), diphenylisosorbide, acrylonitrile butadiene styrene (ABS), polyethylene terephthalate glycol-modified (PETG), polyethylene terephthalate—isophthalic acid copolymer (PET-IPA), polyethylene terephthalate naphthalene (PETN), polybutyrate adipate terephthalate (PBAT) and styrene-ethylene-butylene-ethylene (SEBS).

In some embodiments the petroleum-based polymer is selected from the group consisting of acrylonitrile butadiene styrene (ABS), polycarbonate (PC), polyoxymethylene (POM), polyketone (PK), polyethylene (PE), polypropylene (PP), polyvinyl acetate (PVA), polymethyl methacrylate (PMMA), polyethylene terephthalate glycol-modified (PETG), polyethylene terephthalate—isophthalic acid copolymer (PET-IPA), polyethylene terephthalate naphthalene (PETN), polybutyrate adipate terephthalate (PBAT), thermoplastic polyurethane (TPU), modified thermoplastic olefin (mTPO) and styrene-ethylene-butylene-ethylene (SEBS).

In some embodiments the recycled polymer is selected from the group consisting of polylactic acid (PLA), polyethylene (PE), polypropylene (PP), polyglycolic acid (PGA), poly(lactide-co-glycolide) (PLGA), polybutylene succinate (PBS), polytrimethylene furandicarboxylate (PTF), polyhydroxybutyrate (PHB), polyhydroxyvalerate (PHV), poly(hydroxybutyrate-hydroxyvalerate) (PHBV), polyamide (PA), polyester amide (PEA), polyethylene furanoate (PEF), polyebutylene furanoate (PBF), polytrimethyle furanoate (PTF), polyethylene terephthalate (PET), polyethylene terephthalate glycol-modified (PETG), polyethylene terephthalate—isophthalic acid copolymer (PET-IPA), polyethylene terephthalate naphthalene (PETN), polybutylene terephthalate (PBT), polytrimethylene terephthalate (PTT), thermoplastic polyurethane (TPU), modified Thermoplastic olefin (mTPO), cellulose acetate (CA), thermoplastic starch (TPS), diphenylisosorbide, polyvinyl acetate (PVA), polymethyl methacrylate (PMMA), acrylonitrile butadiene styrene (ABS), polybutyrate adipate terephthalate (PBAT), styrene-ethylene-butylene-ethylene (SEBS), polycarbonate (PC), polyoxymethylene (POM) and polyketone (PK).

In some embodiments the resin comprises one bio-based polymer and no hybrid bio-based polymers. In other embodiments the resin comprises two bio-based polymers and no hybrid bio-based polymers. In yet other embodiments the resin comprises three bio-based polymers and no hybrid bio-based polymers. In still other embodiments the resin comprises four, five, six or seven bio-based polymers and no hybrid bio-based polymers.

In some embodiments the resin comprises one hybrid bio-based polymer and no bio-based polymers. In other embodiments the resin comprises two hybrid bio-based polymers and no bio-based polymers. In yet other embodiments the resin comprises three hybrid bio-based polymers and no bio-based polymers. In still other embodiments the resin comprises four, five, six or seven hybrid bio-based polymers and no bio-based polymers.

In some embodiments the resin comprises one bio-based polymer and one hybrid bio-based polymer. In other embodiments the resin comprises two bio-based polymers and one hybrid bio-based polymer. In yet other embodiments the resin comprises three bio-based polymers and one hybrid bio-based polymers. In other embodiments the resin comprises one bio-based polymer and two hybrid bio-based polymers. In yet other embodiments the resin comprises one bio-based polymer and three hybrid bio-based polymers.

In some embodiments the resin comprises at least one recycled polymer and no bio-based polymers and no hybrid bio-based polymers. In other embodiments the resin comprises at least one recycled polymer and at least one bio-based polymer and no hybrid bio-based polymers. In other embodiments the resin comprises at least one recycled polymer and at least one hybrid bio-based polymer and no bio-based polymers. In yet other embodiments the resin comprises at least one recycled polymer and at least one bio-based polymer and at least one hybrid bio-based polymer.

In some embodiments the amount of bio-based polymer in the resin is at least 25% (w/w) based on the total weight of the resin, for example at least 30% (w/w), such as at least 40% (w/w) based on the total weight of the resin. In some embodiments the amount of bio-based polymer in the resin is at least 50% (w/w), such as at least 60% (w/w), for example at least 70% (w/w), such as at least 80% (w/w), for example at least 90% (w/w), such as at least 95% (w/w) based on the total weight of the resin.

In other embodiments the amount of hybrid bio-based polymer in the resin is at least 25% (w/w) based on the total weight of the resin, for example at least 30% (w/w), such as at least 40% (w/w) based on the total weight of the resin. In some embodiments the amount of hybrid bio-based polymer in the resin is at least 50% (w/w), such as at least 60% (w/w), for example at least 70% (w/w), such as at least 80% (w/w), for example at least 90% (w/w), such as at least 95% (w/w) based on the total weight of the resin.

In yet other embodiments the amount of recycled polymer in the resin is at least 25% (w/w) based on the total weight of the resin, for example at least 30% (w/w), such as at least 40% (w/w) based on the total weight of the resin. In some embodiments the amount of recycled polymer in the resin is at least 50% (w/w), such as at least 60% (w/w), for example at least 70% (w/w), such as at least 80% (w/w), for example at least 90% (w/w), such as at least 95% (w/w) based on the total weight of the resin.

In some embodiments the resin comprises a mixture of recycled polymers and petroleum-based polymers in which the amount of recycled polymer in the resin is at least 25% (w/w) based on the total weight of the resin, for example at least 30% (w/w), such as at least 40% (w/w) based on the total weight of the resin. In some embodiments the amount of recycled polymer in the resin is at least 50% (w/w), such as at least 60% (w/w), for example at least 70% (w/w), such as at least 80% (w/w), for example at least 90% (w/w), such as at least 95% (w/w) based on the total weight of the resin.

The hybrid bio-based polymers may also be characterized by their content of bio-based carbon per total carbon content. In some embodiments the content of bio-based carbon in the hybrid bio-based polymer is at least 25% based on the total carbon content, such as for example at least 30% or at least 40%. In other embodiments the content of bio-based carbon in the hybrid bio-based polymer is at least 50% based on the total carbon content, such as at least 60%, for example at least 70%, preferably at least 80%, more preferred at least 90%.

The term “bio-based carbon” as used herein refers to the carbon atoms that originate from the biomass that is used as substrate in the production of monomers which form part of the bio-based polymers and/or the hybrid bio-based polymers. The content of bio-based carbon in the hybrid bio-based polymer can be determined by Carbon-14 isotope content as specified in ASTM D6866 or CEN/TS 16137 or an equivalent protocol.

The recycled polymers may also be characterized by their content of bio-based carbon per total carbon content. In some embodiments the content of bio-based carbon in the recycled polymer is at least 25% based on the total carbon content, such as for example at least 30% or at least 40%. In other embodiments the content of bio-based carbon in the recycled polymer is at least 50% based on the total carbon content, such as at least 60%, for example at least 70%, preferably at least 80%, more preferred at least 90%.

Also the resin comprising a bio-based polymer and/or a hybrid bio-based polymer and/or a recycled polymer may be characterized by its content of bio-based carbon per total carbon content. In some embodiments the content of bio-based carbon in the resin is at least 25% based on the total carbon content in the resin, such as for example at least 30% or at least 40%. In other embodiments the content of bio-based carbon in the resin is at least 50% based on the total carbon content in the resin, such as at least 60%, for example at least 70%, such as at least 80%, preferably at least 90% or at least 95%.

The toy building element is of the LEGO®-size or the LEGO® DUPLO®-size. In preferred embodiments the toy building brick is of the LEGO®-size.

It is important that the toy building elements are capable of withstanding elastic deformation in particular for their function as construction elements. Hence, the elastic modulus of the biopolymeric material should be at least 1500 MPa, such as at least 1700 MPa and preferably at least 2000 MPa when measured according to ISO 527.

The present invention also relates to a method for the manufacture of a toy building element comprising the steps of

a) providing a resin comprising at least one bio-based polymer and/or at least one hybrid bio-based polymer and/or a recycled polymer, and

b) processing said resin.

Suitable resins to be provided and processed in the method include those described above.

In some embodiments the resin comprising said at least one bio-based polymer and/or at least one hybrid bio-based polymer and/or recycled polymer is provided by mixing the bio-based polymer and/or hybrid bio-based polymer and/or the recycled polymer with other additives, such as for example lubricants, impact modifiers, flame retardants, plasticizers, fillers, colorants, slip agents, surface improvers, nucleating agents, compatibilizers and antioxidants. Optionally the bio-based polymer and/or hybrid bio-based polymer and/or recycled polymer may also be mixed with other polymers that form part of the resin.

In other embodiments the resin comprising at least one bio-based polymer and/or at least one hybrid bio-based polymer and/or recycled polymer is provided by mixing the bio-based polymer and/or hybrid bio-based polymer and/or recycled polymer with petroleum-based polymers.

In yet other embodiments the resin is made of only one bio-based polymer, such as for example polylactic acid. In such cases, mixing is not required to provide the resin; the resin is provided simply by unpacking the resin bought from the supplier. In other embodiments the resin is made of only one hybrid bio-based polymer, in which case mixing is also not required to provide the resin. In yet other embodiments the resin is made of recycled polymeric material, in which case mixing is also not required to provide the resin.

In some embodiments the toy building element is manufactured by injection moulding. In such embodiments the mixing of the bio-based polymer and/or hybrid bio-based polymer and/or the recycled polymer with other additives and/or other petroleum-based polymers may take place prior to feeding the resin to the injection moulding machine. In some embodiments the mixing may be performed as a dry mixing step. In other embodiments the mixing may be performed by using a compounding step in an extrusion machine prior to the injection moulding step. Alternatively the mixing may take place during feeding the resin to the injection moulding machine.

In some embodiments the toy building element is manufactured by additive manufacturing. Suitable examples of additive manufacturing techniques are those in which the toy building element is built by photopolymerization additive manufacturing or thermoplastic additive manufacturing, such as liquid-based additive manufacturing, toner-based additive manufacturing, powder-based additive manufacturing or granulate-based additive manufacturing.

### EXAMPLES

In the examples below it is described how a toy building brick is manufactured by injection moulding or by additive manufacturing. The bricks manufactured in Examples 1 and 2 were subsequently tested by the “Brick assembly test”. This test evaluates the frictional coupling force with which two bricks are assembled and separated. The bricks manufactured in Example 3 were subsequently tested by the “Drop test” and the “Charpy v-notch test”. These tests evaluate the impact strength of the injection moulded bricks.

### Brick Assembly Test

### Purpose:

Evaluate and score the physical the effort it requires to assemble and subsequently disassemble traditional LEGO® 2*4 bricks (test specimen) produced in a certain material.

### Test Person:

The test person is an average adult.

### Test Conditions:

The test should be performed indoor with a temperature of 20-25 degrees C. and 20-65% relative humidity.

### Test Specimen:

The test is conducted on two similar coloured LEGO® 2*4 bricks which have been produced in a relevant material. Following production, the test specimens should be stored in indoor conditions at 20-25 degrees C. and 20-65% relative humidity.

### Test:

The test is carried out within 2-10 days after production. Two test specimens will be used in the test and the upper-side of one brick will be aligned with the lower-side of the other brick and then they will be assembled and disassembled using all knobs on the upper-side and all tubes on the lower-side. The test person will assemble and immediately disassemble the test bricks without twisting by hand for a total of 10 cycles in a row. For each cycle, the test person will note a test score as specified below.

### Scoring:

The scorings of the first two assembly/disassembly cycles are disregarded. The final test score is reported as the average score obtained for cycles 3-10.

| Test score | Description |
|---|---|
| 1 | Little effort is required to assemble the bricks and the bricks |
| | feel very loosely connected. It requires little to no effort to |
| | disassemble the bricks. |
| 5 | Low to medium effort is required to assemble the bricks and |
| | the bricks feel well connected. It requires low to medium |
| | effort to disassemble the bricks. |
| 10 | Medium to high effort is required to assemble the bricks and |
| | once fully assembled the bricks feel very tightly connected. It |
| | requires maximum effort for the test person to disassemble the |
| | bricks. |

If it is not possible to disassemble a set of assembled bricks by hand, then the test specimen receives a score of ND in the test.

An acceptable material for use in the manufacturing of toy building elements will receive an average test score in the range of 3 to 7.

A commercial available LEGO® 2*4 brick produced in ABS receives per definition a score of 5.

### Drop Test

### Purpose:

Evaluate the impact strength of traditional LEGO® 2*4 bricks (also referred to as test specimen) produced in a certain material by dropping an iron plumb on to a test brick from various heights to determine the specific height at which the test specimen fails. A traditional LEGO® 2*4 brick is shown in FIG. 1.

### Test Person:

The test person is an average adult.

### Test Conditions:

The test should be performed indoor with a temperature of 20-25 degrees C. and 20-65% relative humidity.

### Test Specimen:

The test is conducted on similar coloured traditional LEGO® 2*4 bricks which have been produced in a relevant material. Following production, the test specimens should be stored at indoor conditions at 20-25 degrees C. and 20-65% relative humidity.

### Test Equipment:

The test equipment is similar to that described in the safety standard EN 71-1: 2014 Mechanical and Physical Properties, section 8.7; Impact test. The plumb is dropped on to the test specimen from different specified drop heights. The plumb is fitted with an axle to hold it in place before the drop and a release mechanism is built into the axle which enables a controlled timing for the drop by pulling a split. The holder of the plumb is connected to a vertical rod and the drop height is controlled by sliding the holder of the plumb up and down this vertical rod. The total plumb/axle weight is 1.00 kg and the plumb has a diameter of 8 cm. The base plate of the test equipment which holds the test specimen is constructed in iron.

Test: The test is carried out within 2-10 days after production according to the following procedure:
The plumb is fixed in position where the bottom of the plumb is 10 cm above the base plate.
The test specimen is placed on the base plate directly under the plumb with the coupling knobs on the upper-side facing downwards and the complementary tubes on the lower-side facing upwards.
The plumb is dropped on to the test brick and the brick is inspected for signs of failure, i.e. ruptures or cracks.
If the test specimen shows no sign of failure the plumb is again placed in the holder and the height of the plumb is increased by 2 cm.
A new test specimen is placed below the plumb as described above and the plumb is once again released followed by inspection of the test specimen.
This procedure is repeated and the plumb height increased in steps of 2 cm until a certain height is reached where the test specimen fails. At this height a new second test specimen is tested and if this specimen also fails then the plumb height is recorded as the failure height. In case the second specimen does not fail then the plumb height is further increased by 2 cm and a new specimen is tested.
The final failure height is described as the plumb height that causes two consecutive failures.
   Charpy v-Notch Test

Moulded plastic rods with dimensions of 6.0×4.0×50.0 mm³, B×W×H, and in the relevant material to be tested were cut according to ISO 179-1/1 eA with a notch cutter (ZNO, Zwick, Germany) with a notch tip diameter of 0.5 mm. The notched specimens were placed with v-notch opposite pendulum and tested in a pendulum impact machine (HOT, Zwick, Germany) according to the principles described in ISO 179-1:2010.

### Example 1: Manufacture of an Injection Moulded Toy Building Brick of the LEGO®-Size

Polylactic acid (PLA) material (3100HP, purchased from Natureworks) was dried at 80 degrees C. for 6 hours. Thereafter the material was injection moulded into LEGO® 2*4 bricks with an Arburg Allrounder 470 E 1000-400 injection moulding machine equipped with a 30 mm screw.

The injection moulding parameters were as follows:

Melt temperature of PLA: 190 degrees C.

Mould temperature: 110 degrees C.

Holding pressure: 600 bar

Cooling time: 60 seconds.

The manufactured 2*4 building bricks were tested by 5 people according to the procedure described in the Brick assembly test. The average test score was 10.

The score of the brick assembly test show that the bricks can be assembled and disassembled, but the surface friction of the manufactured toy building brick is high and therefore further modification of the tested PLA resin is required in order to manufacture toy building elements having acceptable surface friction so that two assembled bricks subsequently can be disassembled without requiring too high effort.

### Example 2: Manufacture of an Additively Manufactured Toy Building Brick of the LEGO®-Size

In general the toy building elements can be built using the following description:

The digital CAD file needs to be saved in a file format as STL, 3MF or similar, that can be read by a 3D printer/Additive Manufacturing (AM) machine. This file needs to be imported into the slicing software of the relevant printer. The file will be virtually cut into small horizontal layers. The thickness of these layers/slices is dependent on the printer's resolution. Additional toolpaths within a layer are dependent on the chosen AM technology. For droplet based AM technologies the toolpath is rather a deposition pattern or matrix of droplets. The traditional LEGO® 2*4 bricks will then be produced layer by layer in the respective AM technology.

For manufacturing of elements with an overhang or other complex geometry a support structure may be needed. This structure can either be made of the same material or out of a support material. The manufacturing/deposition process is the same as it is for the building material, as described above. The only difference is that this support structure needs to be removed afterwards. The removal process can be either done manually, semi-automatically in a liquid or chamber or even in a fully automated process.

### Manufacture of a Toy Building Brick Using a Granulate Additive Manufacturing Technique.

In order to print a LEGO® 2*4 toy building brick in PLA (3100HP, purchased from Natureworks) on the ARBURG Freeformer, two types of parameter-sets need to be adjusted. On the machine side, the parameter-set for a spherical evenly extruded droplet shape is needed. Even though the Freeformer is a semi-self-regulating system in terms of material, pressure and movement of the screw, some parameters need to be set manually. On the software side, the toy building element needs to be sliced with the right parameter-set, in order to define the toolpath where the nozzle deposits droplets.

### Machine Parameter-Set:

T_{chamber}=60 degrees C.
T_{nozzle}=200 degrees C.
T_{zone2}=180 degrees C.
T_{zone1}=155 degrees C.
Discharge measure=74%

### Slicing Parameter-Set:

Feed rate continuous extrusion=40
Feed rate discrete extrusion=40
Drop aspect ratio=1.04
Number of border contours=1
Inner compensation factor=0.2
Sorting=Inside out
Area filling overlap with border contour=50%
Start angle=45 degrees
Increment angle=90 degrees
Filling degree=95%

The manufactured 2*4 building bricks were tested by 5 people according to the procedure described in the Brick assembly test. The average test score was 2.

The score of the brick assembly test shows that the bricks can be assembled and disassembled, but the bricks are loosely connected and it requires little to no effort to disassemble the bricks.

The score of the brick assembly test shows that the surface friction of the manufactured toy building brick is low and therefore further modification of the tested PLA is required in order to manufacture toy building elements having acceptable surface friction so that the bricks are less loosely connected.

### Example 3: Manufacture of Injection Moulded Toy Building Bricks of the LEGO®-Size Using PET Resin

The following grades of PET were tested:
Commercial grade post-consumer rPET CB-602R (supplied by Far Eastern New Century (FENC)) with an IV of 0.82 dl/g
Partially bio-based bottle grade PET CB-602AB (supplied by Far Eastern New Century (FENC)) with an IV of 0.77 dl/g. In this grade the MEG monomer is bio-based.

The following grades of impact modifiers were tested:
Lotader® AX8700 (supplied by Arkema), which is a reactive random terpolymer of ethylene, butyl acrylate and glycidyl methacrylate (epoxide functional)
Lotader® 3430 (supplied by Arkema), which is a reactive random terpolymer of ethylene, butyl acrylate and maleic anhydride (anhydride functional)
Metablen® S-2200 (supplied by Mitsubishi Chemical), which is a reactive rubber composed of silicone-acrylate and glycidyl methacrylate (epoxide functional)

PET samples were dried at 150 degrees C. to 50-100 ppm moisture content. Upon ambient cooling of the dried PET samples to below 50 degrees C., the samples were dry blended with impact modifier, in amounts as mentioned in the table below and processed via extrusion (Twin screw, Labtech Engineering Company Ltd, Thailand,) followed by injection moulding (Arburg, Allrounder 470 E 1000-400, 30 mm screw, Germany).

Unfortunately, the mould broke during the experiments and it was therefore substituted. Hence, the bricks produced in trials 3-1 to 3-2 were injection moulded using a different mould than the bricks produced in trials 3-3 and 3-6. The first mould (used in trials 3-1 to 3-2) produces bricks having a certain wall thickness and supporting ribs, whereas the second mould (used in trials 3-3 to 3-6) produces bricks having an increased wall thickness but no supporting ribs. Consequently, the impact strength of the bricks produced using the first mould cannot directly be compared with the impact strength of the bricks produced using the second mould.

| Trial | PET grade | Modifier | Impact bars | 2*4 bricks |
|---|---|---|---|---|
| 3-1 | CB-602R | No | X | X |
| 3-2 | CB-602R | 1% (w/w) AX8700 | — | X |
| 3-3 | CB-602R | 6% (w/w) 3430 | X | X |
| 3-4 | CB-602R | 6% (w/w) S-2200 | X | X |
| 3-5 | CB-602AB | No | X | X |
| 3-6 | CB-602AB | 6% (w/w) AX8700 | X | X |

The injection molding processing parameters were as follows:

Melt temperature: 295 degrees C.

Hot runner temperature: 300 degrees C.

Mould temperature: 20 degrees C.

The obtained 2*4 bricks and impact bars were tested in the Drop test and Charpy v-notch test, respectively, as described above. The results are shown in the table below.

| | Charpy v-notch | Drop test (2*4 brick) |
|---|---|---|
| Trial | (kJ/m2) | Cm |
| 3-1 | 4.2 | 40 |
| 3-2 | — | 44 |
| 3-3 | 4.5 | 38 |
| 3-4 | 4.5 | 44 |
| 3-5 | 4.2 | 36 |
| 3-6 | 5.8 | 66 |

The results show that toy building elements can be produced by injection moulding a resin comprising recycled PET and hybrid bio-based PET polymer, i.e. PET where one of the monomers (MEG) has been produced using biomass as substrate.

1. A toy building element made of a biopolymeric material.

2. The toy building element according to claim 1, wherein the toy building element is manufactured by processing of a resin comprising a bio-based polymer and/or a hybrid bio-based polymer and/or a recycled polymer.

3. The toy building element according to claim 2, wherein the toy building element is manufactured by injection moulding and/or additive manufacturing of a resin comprising a bio-based polymer and/or a hybrid bio-based polymer and/or a recycled polymer.

4. The toy building element according to claim 2, wherein the bio-based polymer is selected from the group consisting of polylactic acid (PLA), polyethylene (PE), polypropylene (PP), polyglycolic acid (PGA), poly(lactide-co-glycolide) (PLGA), polybutylene succinate (PBS), polytrimethylene furandicarboxylate (PTF), polyhydroxybutyrate (PHB), polyhydroxyvalerate (PHV), poly(hydroxybutyrate-hydroxyvalerate) (PHBV), polyimide (PA), polyester amide (PEA), polyethylene furanoate (PEF), polyebutylene furanoate (PBF), polyethylene terephthalate (PET), polyethylene terephthalate glycol-modified (PETG), polyethylene terephthalate—isophthalic acid copolymer (PET-IPA), polyethylene terephthalate naphthalene (PETN), polybutylene terephthalate (PBT), polytrimethylene terephthalate (PTT), thermoplastic polyurethane (TPU), cellulose acetate (CA), thermoplastic starch (TPS), diphenylisosorbide, polyvinyl acetate (PVA) and polymethyl methacrylate (PMMA).

5. The toy building element according to claim 2, wherein the hybrid bio-based polymer is selected from the group consisting of poly(lactide-co-glycolide) (PLGA), polybutylene succinate (PBS), polytrimethylene furandicarboxylate (PTF), polyamide (PA), polyester amide (PEA), polyethylene furanoate (PEF), polyebutylene furanoate (PBF), polyethylene terephthalate (PET), polybutylene terephthalate (PBT), polytrimethylene terephthalate (PTT), thermoplastic polyurethane (TPU), diphenylisosorbide, acrylonitrile butadiene styrene (ABS), polyethylene terephthalate glycol-modified (PETG), polyethylene terephthalate—isophthalic acid copolymer (PET-IPA), polyethylene terephthalate naphthalene (PETN), polybutyrate adipate terephthalate (PBAT) and styrene-ethylene-butylene-ethylene (SEBS).

6. The toy building element according to claim 2, wherein the recycled polymer is selected from the group consisting of polylactic acid (PLA), polyethylene (PE), polypropylene (PP), polyglycolic acid (PGA), poly(lactide-co-glycolide) (PLGA), polybutylene succinate (PBS), polytrimethylene furandicarboxylate (PTF), polyhydroxybutyrate (PHB), polyhydroxyvalerate (PHV), poly(hydroxybutyrate-hydroxyvalerate) (PHBV), polyamide (PA), polyester amide (PEA), polyethylene furanoate (PEF), polyebutylene furanoate (PBF), polytrimethyle furanoate (PTF), polyethylene terephthalate (PET), polyethylene terephthalate glycol-modified (PETG), polyethylene terephthalate—isophthalic acid copolymer (PET-IPA), polyethylene terephthalate naphthalene (PETN), polybutylene terephthalate (PBT), polytrimethylene terephthalate (PTT), thermoplastic polyurethane (TPU), modified Thermoplastic olefin (mTPO), cellulose acetate (CA), thermoplastic starch (TPS), diphenylisosorbide, polyvinyl acetate (PVA), polymethyl methacrylate (PMMA), acrylonitrile butadiene styrene (ABS), polybutyrate adipate terephthalate (PBAT), styrene-ethylene-butylene-ethylene (SEBS), polycarbonate (PC), polyoxymethylene (POM) and polyketone (PK).

7. The toy building element according to claim 2, wherein the amount of bio-based polymer in the resin is at least 25% (w/w) based on the total weight of the resin.

8. The toy building element according to claim 2, wherein the amount of hybrid bio-based polymer in the resin is at least 25% (w/w) based on the total weight of the resin.

9. The toy building element according to claim 2, wherein the amount of recycled polymer in the resin is at least 25% (w/w) based on the total weight of the resin.

10. The toy building element according to claim 2, wherein the content of bio-based carbon per total carbon content in the resin is at least 50%, such as at least 60%, for example at least 70%, preferably at least 80%, more preferred at least 90%.

11. The toy building element according to claim 1, wherein the toy building element is of the LEGO®-size or the LEGO® DUPLO®-size.

12. The toy building element according to claim 2, wherein an elastic modulus of the biopolymeric material is at least 1500 MPa, preferably at least 2000 MPa when measured according to ISO 527

13. A method for the manufacture of a toy building element comprising the steps of:
a) providing a resin comprising at least one bio-based polymer and/or at least one hybrid bio-based polymer and/or a recycled polymer, and
b) processing said resin.

14. The method according to claim 13, wherein the bio-based polymer is selected from the group consisting of polylactic acid (PLA), polyethylene (PE), polypropylene (PP), polyglycolic acid (PGA), poly(lactide-co-glycolide) (PLGA), polybutylene succinate (PBS), polytrimethylene furandicarboxylate (PTF), polyhydroxybutyrate (PHB), polyhydroxyvalerate (PHV), poly(hydroxybutyrate-hydroxyvalerate) (PHBV), polyamide (PA), polyester amide (PEA), polyethylene furanoate (PEF), polyebutylene furanoate (PBF), polyethylene terephthalate (PET), polyethylene terephthalate glycol-modified (PETG), polyethylene terephthalate—isophthalic acid copolymer (PET-IPA), polyethylene terephthalate naphthalene (PETN), polybutylene terephthalate (PBT), polytrimethylene terephthalate (PTT), thermoplastic polyurethane (TPU), cellulose acetate (CA), thermoplastic starch (TPS), diphenylisosorbide, polyvinyl acetate (PVA) and polymethyl methacrylate (PMMA).

15. The method according to claim 13, wherein the amount of bio-based polymer in the resin is at least 25% (w/w) based on the total weight of the resin.

16. The method according to claim 13, wherein the hybrid bio-based polymer is selected from the group consisting of poly(lactide-co-glycolide) (PLGA), polybutylene succinate (PBS), polytrimethylene furandicarboxylate (PTF), polyamide (PA), polyester amide (PEA), polyethylene furanoate (PEF), polyebutylene furanoate (PBF), polyethylene terephthalate (PET), polybutylene terephthalate (PBT), polytrimethylene terephthalate (PTT), thermoplastic polyurethane (TPU), diphenylisosorbide, acrylonitrile butadiene styrene (ABS), polyethylene terephthalate glycol-modified (PETG), polyethylene terephthalate—isophthalic acid copolymer (PET-IPA), polyethylene terephthalate naphthalene (PETN), polybutyrate adipate terephthalate (PBAT), thermoplastic polyurethane (TPU) and styrene-ethylene-butylene-ethylene (SEBS).

17. The method according to claim 16, wherein the amount of hybrid bio-based polymer in the resin is at least 25% (w/w) based on the total weight of the resin.

18. The method according to claim 13, wherein the recycled polymer is selected from the group consisting of polylactic acid (PLA), polyethylene (PE), polypropylene (PP), polyglycolic acid (PGA), poly(lactide-co-glycolide) (PLGA), polybutylene succinate (PBS), polytrimethylene furandicarboxylate (PTF), polyhydroxybutyrate (PHB), polyhydroxyvalerate (PHV), poly(hydroxybutyrate-hydroxyvalerate) (PHBV), polyamide (PA), polyester amide (PEA), polyethylene furanoate (PEF), polyebutylene furanoate (PBF), polytrimethyle furanoate (PTF), polyethylene terephthalate (PET), polyethylene terephthalate glycol-modified (PETG), polyethylene terephthalate—isophthalic acid copolymer (PET-IPA), polyethylene terephthalate naphthalene (PETN), polybutylene terephthalate (PBT), polytrimethylene terephthalate (PTT), thermoplastic polyurethane (TPU), modified Thermoplastic olefin (mTPO), cellulose acetate (CA), thermoplastic starch (TPS), diphenylisosorbide, polyvinyl acetate (PVA), polymethyl methacrylate (PMMA), acrylonitrile butadiene styrene (ABS), polybutyrate adipate terephthalate (PBAT), styrene-ethylene-butylene-ethylene (SEBS), polycarbonate (PC), polyoxymethylene (POM) and polyketone (PK).

19. The method according to claim 18, wherein the amount of recycled polymer in the resin is at least 25% (w/w) based on the total weight of the resin.

20. The method according to claim 13, wherein the toy building element is manufactured by injection moulding and/or additive manufacturing of the resin comprising at least one bio-based polymer and/or at least one hybrid bio-based polymer and/or a recycled polymer.
